(19) United States
(12) Patent Application Publication
(10) Pub. No.: US 2016/0239871 A1
(43) Pub. Date: Aug. 18, 2016

(54) SERVER FOR PROVIDING ADVERTISEMENT AND METHOD OF GENERATING ADVERTISEMENT SCHEDULE

(71) Applicants: Electronics and Telecommunications Research Institute, Daejeon (KR); SAMSUNG ELECTRONICS CO., LTD., Suwon-si Gyeonggi-do (KR)

(72) Inventors: Cho Rong YU, Daejeon (KR); Jong Ho LEA, Suwon-si Gyeonggi-do (KR); Dong Min PARK, Suwon-si Gyeonggi-do (KR); Kwang Il HWANG, Suwon-si Gyeonggi-do (KR); Won RYU, Seoul (KR); Il Gu JUNG, Daejeon (KR)

(21) Appl. No.: 15/045,803

(22) Filed: Feb. 17, 2016

(30) Foreign Application Priority Data
Feb. 17, 2015 (KR) 10-2015-0024288

(51) Int. Cl. G06Q 30/02

(52) U.S. Cl. CPC G06Q 30/0264

(57) ABSTRACT

The present disclosure relates to an advertisement providing server and an advertisement schedule generating method performed by the advertisement providing server. Specifically, the advertisement schedule generating method collects an advertisement viewing history of a user and schedules an advertisement suitable for the user by time based on the advertisement viewing history.

### CROSS-REFERENCE TO RELATED APPLICATION

This application claims the priority benefit of Korean Patent Application No. 10-2015-0024288, filed on Feb. 17, 2015, in the Korean Intellectual Property Office, the disclosure of which is incorporated herein by reference.

### BACKGROUND

1. Field of the Invention

Embodiments relate to an advertisement providing server and an advertisement schedule generating method performed by the advertisement providing server, and more particularly to an advertisement providing server and an advertisement schedule generating method which generate an advertisement schedule based on an advertisement viewing history of a viewing household in order to efficiently provide an advertisement to the viewing household having a user device.

2. Description of the Related Art

Korea Advertising Society defines an advertisement as a form of paid non-face-to-face communication using public media for an advertiser to persuade or have an influence on audiences. As the spread of user devices, such as smart phones and smart TVs, and popularization of applications lead to growing interest in mobile advertising and blurred boundaries of existing advertising areas, advertisement display media and platform areas are separated and advertising platforms are developed.

Here, an advertising platform may refer to a system for linking functions of an advertiser, an advertising agency, an advertisement display medium provider, an advertising effect assessment institution, or the like in order to support all stages of an advertising service which creates, distributes, and consumes an advertisement. Accordingly, the advertising platform provides a solution for participants in consuming the advertisement to make a profit. Advertising platforms may be classified into mobile, internet, video and social platforms according to user device and domain. A user device in a smart TV form is an emerging advertising platform domain linked to an Internet or mobile advertising platform, which is spotlighted as a new pioneered advertising platform market which is similar to an Internet advertising service but has lean-back characteristics of a TV.

With the popularization of advertising platforms receive, various advertisement display methods are suggested. That is, as an advertising platform, rich media advertising is suggested which displays advertisements using various ways, for example, a conventional bar-type banner advertisement, a banner advertisement expanding upon clicking the advertisement according to user's interest, a plurality of banners rotating, or the like. Further, rich media advertising is continuously being developed to be optimized to a user device, such as a smart phone, a tablet PC, a smart TV, or the like.

An advertising platform is to display an advertisement to a greater number of user devices in order that an advertiser or advertising agency which provides the advertisement makes a profit through the displayed advertisement. Accordingly, the advertising platform displays advertisements not only conventionally to smart TVs but also to various user devices, such as smart phones and tablet PCs.

Here, the advertising platform schedules advertisements according to requests from advertisers or advertising agencies in order to display advertisements depending on purposes and provides the scheduled advertisements to users viewing advertisements in a uniform manner.

Advertisement scheduling in the uniform manner is effective for displaying scheduled advertisements but is not expected to have various advertising effects through advertisements displayed to advertising targets. That is, when advertisement viewing users want different advertisements depending on life pattern, interest or tendency, the same advertisement may bring different advertising effects.

Thus, there is needed a method for scheduling an advertisement suitable for a user based on an advertisement viewing history of the user viewing an advertisement displayed through a user device.

### SUMMARY

An aspect provides an advertisement schedule generating method which schedules an advertisement suitable for a user based on an advertisement viewing history of the user viewing the advertisement.

Another aspect also provides an advertisement schedule generating method which displays a different advertisement by time according to an advertisement schedule based on an advertisement viewing history of a user.

According to an aspect, there is provided a method of generating an advertisement schedule performed by an advertisement providing server, the method including collecting an advertisement viewing history of a user from a user device, and generating an advertisement schedule for the user corresponding to the collected advertisement viewing history.

The collecting may include collecting an advertisement viewing history including a time at which the user views an advertisement and a category of the advertisement displayed at the time.

The generating may include determining a distribution state of advertisements displayed by time at which the user views the advertisements based on the advertisement viewing history.

The generating may include generating the advertisement schedule for the user by adjusting proportions of advertisements included in an advertisement group to be recommended to the user based on the distribution state of the displayed advertisements.

The advertisement group may include an Uprising advertisement newly added to be displayed to the user based on a registration date of an advertisement registered in the advertisement providing server.

The advertisement group may include a Steady advertisement displayed to the user which a steadily increasing number of users views based on a preset number of advertisement display times.

The advertisement group may include a Best advertisement recommendable according to a characteristic of the user in view of an advertisement displayed to the user and preference for an advertisement viewed by the user.

The advertisement group may include at least one Serendipity advertisement among an advertisement related to an advertisement display time and a default advertisement based on a profile of the user.

The generating may include generating an advertisement schedule with proportions of advertisements in an advertisement group being adjusted according to a preset priority based on at least one of the collected advertisement viewing history, preference of the user for an advertisement, and a profile of the user.

The generating may include generating an advertisement schedule for recommending an advertisement to the user by certain time corresponding to an estimated time at which an advertisement is displayable to the user based on the advertisement viewing history.

According to another aspect, there is also provided a method of generating an advertisement schedule performed by an advertisement providing server, the method including collecting an advertisement viewing history of a user who views an advertisement displayed through a user device, determining a distribution state of advertisements displayed by time to the user based on the collected advertisement viewing history and a profile of the user, and generating an advertisement schedule for the user using an advertisement group in which advertisements to be recommended to the user are classified according to the determined distribution state.

The determining may include determining the distribution state according to characteristics of the user and a household member using information on the household member included in the profiled of the user.

The generating may include generating an advertisement schedule with proportions of advertisements in an advertisement group being adjusted according to a preset priority based on at least one of the collected advertisement viewing history, preference of the user for an advertisement, and a profile of the user.

The generating may include generating an advertisement schedule for recommending an advertisement to the user by certain time corresponding to an estimated time at which an advertisement is displayable to the user based on the advertisement viewing history.

According to still another aspect, there is also provided an advertisement providing server including a receiver configured to collect an advertisement viewing history of a user from a user device, a processor configured to generate an advertisement schedule for the user corresponding to the collected advertisement viewing history, and a transmitter configured to transmit the generated advertisement schedule to the user device.

The processor may determine a distribution state of advertisements displayed by time at which the user views the advertisements based on the advertisement viewing history.

The processor may generate the advertisement schedule for the user by adjusting proportions of advertisements included in an advertisement group to be recommended to the user based on the distribution state of the displayed advertisements.

According to yet another aspect, there is also provided an advertisement providing server including a receiver configured to collect an advertisement viewing history of a user who views an advertisement displayed through a user device, a processor configured to determine a distribution state of advertisements displayed by time to the user based on the collected advertisement viewing history and a profile of the user to generate an advertisement schedule for the user using an advertisement group in which advertisements to be recommended to the user are classified, and a transmitter configured to transmit the generated advertisement schedule to the user device.

The processor may determine the distribution state according to characteristics of the user and a household member using information on the household member included in the profiled of the user.

The processor may generate the advertisement schedule for the user by adjusting proportions of advertisements included in an advertisement group to be recommended to the user based on the distribution state of the displayed advertisements.

An advertisement schedule generating method according to an aspect may schedule an advertisement suitable for a user based on an advertisement viewing history of the user viewing an advertisement, thereby causing user's interest in the advertisement and improving user's satisfaction with the advertisement.

An advertisement schedule generating method according to an aspect may display a different advertisement by time according to an advertisement schedule suited to an advertisement viewing history of a user, thereby allowing advertisers to make a profit through displayed advertisements different depending on users.

An advertisement schedule generating method according to an aspect may consider characteristics of a viewing household viewing an advertisement by time based on an advertisement viewing history, thereby scheduling an advertisement by time meeting a user standard.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an overall configuration of an advertisement providing server according to an example embodiment;

FIG. 2 illustrates a detailed configuration of an advertisement providing server according to an example embodiment;

FIG. 3 illustrates an advertisement viewing history and an advertisement schedule according to an example embodiment;

FIG. 4 illustrates an advertisement viewing history by time according to an example embodiment;

FIG. 5 illustrates a process of generating an advertisement schedule according to an example embodiment;

FIG. 6 illustrates a process of generating a different advertisement schedule depending on the presence of an advertisement viewing history according to an example embodiment;

FIG. 7 is a flowchart illustrating a process of selecting an advertisement group using an advertisement schedule generating method according to an example embodiment; and

FIG. 8 is a flowchart illustrating a process of adjusting portions of advertisements in an advertisement group using an advertisement schedule generating method according to an example embodiment.

### DETAILED DESCRIPTION

Hereinafter, embodiments of the present disclosure will be described in detail with reference to the accompanying drawings.

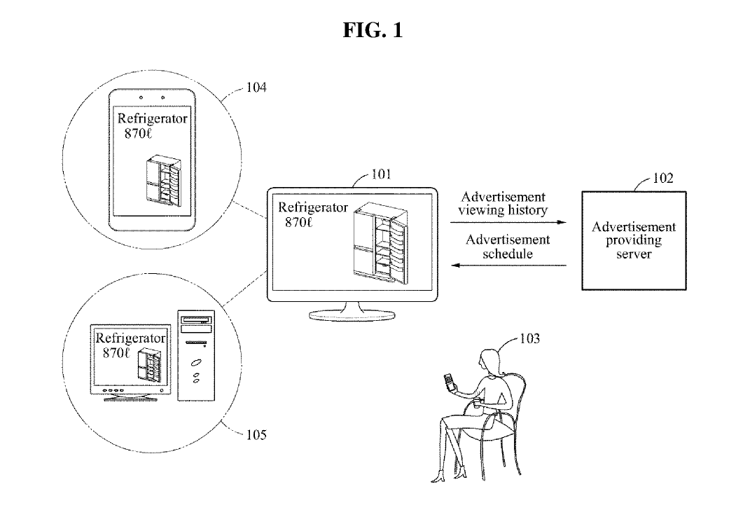

FIG. 1 illustrates an overall configuration of an advertisement providing server according to an example embodiment.

Referring to FIG. 1, the advertisement providing server 102 may generate an advertisement to be displayed a user and an advertisement schedule for the user based on a contract of an advertisement with an advertiser or advertising agency which provides an advertisement. For example, the advertisement providing server 102 may perform an operation of generating an advertisement schedule based on an advertising platform which performs an advertisement scheduling function of displaying an advertisement to a user through a contract with the advertiser or advertising agency.

Specifically, the advertisement providing server 102 may perform a contract process for an advertisement provided from the advertiser or advertising agency. The advertisement providing server 102 may perform the contract process the advertisement with the advertiser or advertising agency regarding a desired advertising time, an advertising target user (a target for the advertisement, a user group by profile, or the like), numbers of hourly/daily/weekly advertising times, an advertising period, or the like.

The advertisement providing server 102 may contract an advertisement through the contract process and schedule an advertisement to be displayed to the user based on the contracted advertisement. The advertisement providing server 102 may perform an advertisement scheduling function of scheduling an advertisement and an advertisement transmitting function of providing a user with an advertisement according to a completed advertisement schedule. Here, the advertisement providing server 102 may create an advertisement schedule to provide advertisements to a user based on advertisement contract information and various pieces of advertisement schedule information.

Further, the advertisement providing server 102 displays an advertisement through a user device 101 according to the advertisement schedule. For example, the user device 101 may include a smart TV 101, a mobile phone 104, a desktop computer 105, and the like which are capable of displaying an advertisement. The advertisement providing server 102 may transmit an advertisement only when the user device is ready to transmit an advertisement. For example, the advertisement providing server 102 may transmit an advertisement when the user device is turned on and is in a state to receive content through various channels.

Here, the advertisement providing server 102 may generate an advertisement schedule customized to the user according to an advertisement viewing history of the user and display an advertisement suitable for the user according to the generated advertisement schedule.

Specifically, the advertisement providing server 102 may generate an hourly advertisement schedule suitable for the user based on the advertisement viewing history of the user. The advertisement providing server 102 may collect time information on a time at which the advertisement viewing history occurs based on the advertisement viewing history of the user and determine a distribution state of advertisements displayed by time to the user based on the collected time information. Here, the time information may include a time, a day, a channel, and the like on which the user views the user device 101.

That is, the advertisement providing server 102 may analyze basic information on an advertisement displayed to the user within the time information of the user, thereby determining a distribution state of advertisements displayed by time based on the advertisement viewing history. Here, the basic information on the advertisement may include various pieces of information, such as i) identification information for identifying the advertisement, ii) information on a channel on which the advertisement is displayed, and iii) information on a time at which the advertisement is displayed through a channel. That is, the advertisement providing server 102 may classify advertisements displayed to the user according to category to determine a distribution state of advertisements.

For example, the advertisement providing server 102 may identify, based on the time information according to the advertisement viewing history of the user, that the user views the user device 101 from 2 p.m. to 4 p.m. The advertisement providing server 102 may analyze based on a category in the basic information on the advertisement that an advertisement for a home appliance, an advertisement for a daily necessity and an advertisement for a basic cosmetic product are displayed to the user from 2 p.m. to 4 p.m. according to the time information. Accordingly, the advertisement providing server 102 may identify that the three advertisements are displayed to the user for 2 hours.

The advertisement providing server 102 may consider members of a viewing household using the user device 101 and may identify a usage pattern in which the user views the user device 101 according to an advertisement viewing history collected at a weekend (Saturday and Sunday).

That is, the advertisement providing server 102 may collect an advertisement viewing history of advertisement viewing from 10 a.m. to 12 p.m. and from 5 p.m. to 8 p.m. at weekends. The advertisement providing server 102 may identify that advertisements are displayed more frequently to the user at a particular time on a particular day based on the periodically collected advertisement viewing history at weekends.

The advertisement providing server 102 may generate an advertisement schedule suitable for the user according to an analysis result based on the advertisement viewing history of the user. Here, the advertisement providing server 102 may create an advertisement scheduling condition of the user according to the analysis result and generate an advertisement schedule according to the created advertisement scheduling condition.

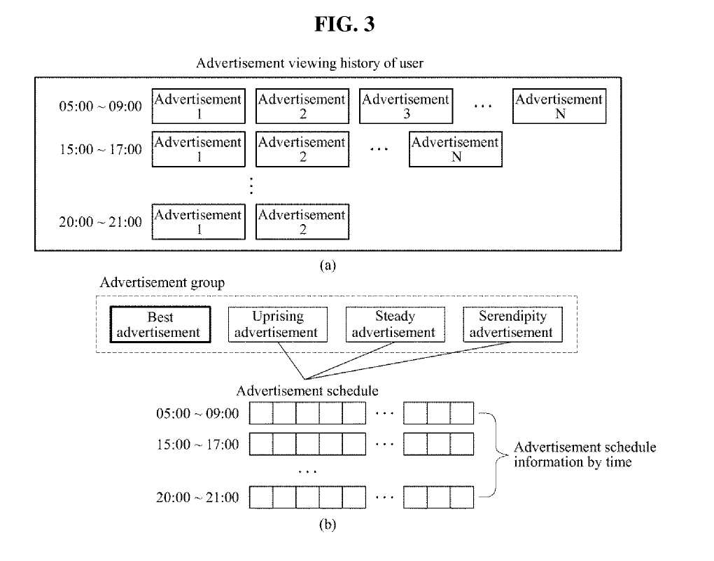

Here, the advertisement scheduling condition may refer to a condition for determining proportions of advertisements in an advertisement group to be recommended to the user. That is, the advertisement providing server 102 may generate the advertisement schedule for the user by adjusting proportions of advertisements in the advertisement group to be recommended to the user. The advertisement group may be divided into an Uprising advertisement, a Best advertisement, a Steady advertisement, and a Serendipity advertisement according to characteristics of advertisements to be recommended to the user. A configuration of the advertisement group will be described in detail with reference to FIG. 3.

Ultimately, the advertisement providing server 102 may analyze advertisements displayed by time to the user viewing the user device 101 in order to predict tendencies of the advertisements displayed to the user and to extract an advertisement suitable for the user. The advertisement providing server 102 may generate an advertisement schedule suitable for the user by adjusting proportions of advertisements in an advertisement group based on a distribution state of analyzed advertisements by time.

Further, the advertisement providing server 102 may need a static information analysis function of acquiring and comparing static information on an advertisement scheduling time to assign a weighting. The advertisement providing server 102 may have an advertisement proportion adjusting function of actually setting, modifying and changing advertisement proportions and an advertisement scheduling function of scheduling an advertisement according to an advertisement proportion.

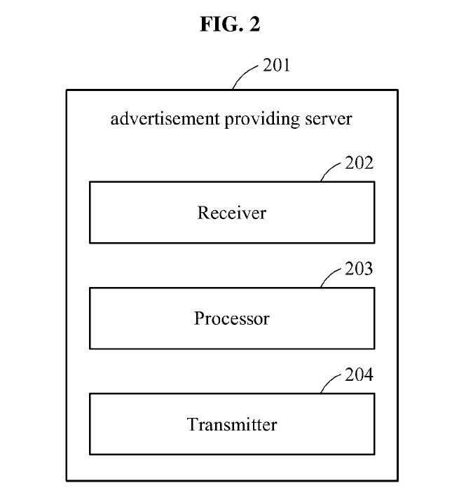

FIG. 2 illustrates a detailed configuration of an advertisement providing server according to an example embodiment.

Referring to FIG. 2, the advertisement providing server 201 may include a receiver 202 to collect an advertisement viewing history of a user, a processor 203 to generate an advertisement schedule according to the advertisement viewing history, and a transmitter 204 to provide an advertisement according to the advertisement schedule.

Specifically, the receiver 202 may collect an advertisement viewing history of a user from a user device. Here, the receiver 202 may collect an advertisement viewing history on an advertisement displayed to the user when power is supplied to the user device. Here, the advertisement viewing history may include a time at which the user views the advertisement and a category of the advertisement displayed at the time.

The processor 203 may store the advertisement viewing history of the user collected by the receiver 202. The processor 203 may generate an advertisement schedule for the user corresponding to the advertisement viewing history of the user.

Specifically, the processor 203 may determine a distribution state of advertisements displayed by time at which the user views the advertisement based on the advertisement viewing history. The processor 203 may generate an advertisement schedule for the user by adjusting proportions of advertisements included in an advertisement group to be recommended to the user based on the determined distribution state of the advertisements. Here, the processor 203 may generate an advertisement schedule suitable for the user according to an advertisement scheduling condition in order to adjust the proportions of the advertisements included in the advertisement group.

That is, the processor 203 may adjust the proportions of the advertisements included in the advertisement group according to the advertisement scheduling condition. The advertisement scheduling condition may refer to a condition to be considered according to characteristics of the advertisements included in the advertisement group.

For example, a Serendipity advertisement included in the advertisement group may include an advertisement related to an advertisement display time and a default advertisement based on a user profile as the advertisement scheduling condition. That is, it may be identified whether a user profile is present before adjusting proportions of specific advertisements belonging to the Serendipity advertisement.

This is because as the Serendipity advertisement includes the advertisement related to the advertisement display time and the default advertisement, a different advertisement is extracted according to a target to which an advertisement is displayed. That is, the Serendipity advertisement may include a target advertisement defined upon an advertising contract, an advertisement group compulsory by an advertising platform operator, and an advertisement indicating static conditions related to a season/period/advertising date. The Serendipity advertisement may be displayed to a limited user or at a limited time set by an advertiser or advertising agency in a time.

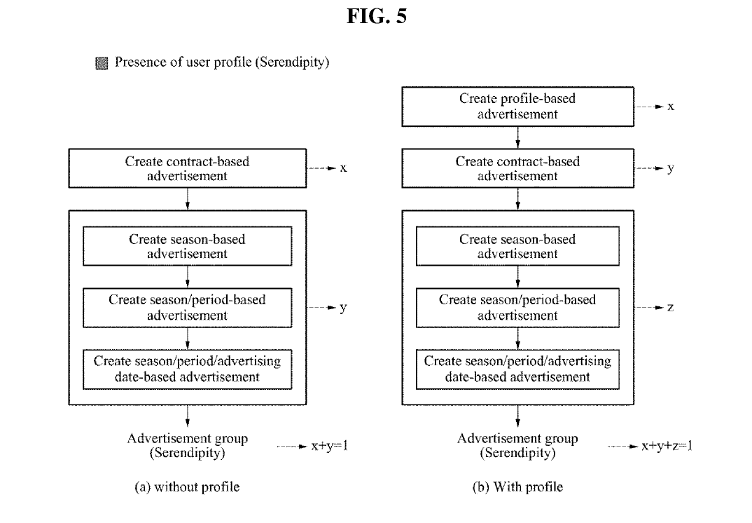

Thus, in order to adjust a proportion of the Serendipity advertisement in the advertisement group, different advertisements may generally be extracted according to criteria based on the advertisement scheduling condition, which will be described in detail with reference to FIG. 5.

Subsequently, the processor 203 may adjust proportions of an Uprising advertisement, a Best advertisement and a Steady advertisement included in the advertisement group, thereby generating the optimized advertisement schedule based on the advertisement viewing history of the user.

Here, the processor 203 may provide an advertisement recommending function of creating an advertisement according to proportions of advertisements included in the adjusted advertisement group and an advertisement blocking rule function of restricting an advertisement according to constraints in displaying an advertisement. Here, the advertisement blocking rule function may be set up for public interest to restrict advertisements which exert an evil influence on social conventions and norms or disturb the public order and to protect a vulnerable class of people from harmful advertising, and be designed to be set by a server administrator based on rules.

FIG. 3 illustrates an advertisement viewing history and an advertisement schedule according to an example embodiment.

Referring to (a) of FIG. 3, an advertisement providing server may collect an advertisement viewing history of a user from a user device. Here, the advertisement providing server may collect an advertisement viewing history including a time at which the user views an advertisement and a category of the advertisement displayed at the time. The advertisement providing server may determine an advertisement displayed according to time, date, and day on which the user views an advertisement and each condition based on the collected advertisement viewing history.

The advertisement providing server may reflect a result of analyzing the advertisement viewing history in an advertisement scheduling condition. The advertisement providing server may reflect the analysis result to the advertisement scheduling condition in order to reflect a characteristic of a different tendency of each user to watch an advertisement.

Referring to (b) of FIG. 3, the advertisement providing server may adjust proportions of advertisements included in an advertisement group according to the analysis result-reflected advertisement scheduling condition. The advertisement group may be divided into an Uprising advertisement, a Best advertisement, a Steady advertisement, and a Serendipity advertisement according to characteristics of advertisements to be recommended to the user. Each advertisement may be defined as follows.

(1) The Uprising advertisement may refer to a newly registered advertisement, which is to be displayed according to an advertising contract with an advertiser or advertising agency. That is, the Uprising advertisement may refer to a new advertisement additionally registered within seven days according to the advertising contract or a new advertisement registered according to criteria determined by a server administrator.

For example, the Uprising advertisement may refer to an advertisement for a front-loading washing machine newly released by ** Electronics in February 2015, which is newly registered in the past seven days.

(2) The Best advertisement may refer to an advertisement considering user characteristics based on an advertisement recommendation algorithm That is, the Best advertisement may refer to an advertisement recommended according to user characteristics in view of advertisements displayed to a user and preference for advertisements viewed by a user. That is, the Best advertisement may refer to an advertisement created corresponding to an assessment of a displayed advertisement and by a user and user preference for a displayed advertisement based on the advertisement already displayed to the user.

For example, as the Best advertisement, an advertisement in a beauty care category suitable for a user may be extracted corresponding to user assessments and preference for beauty care advertisements for wrinkle treatment.

(3) The Steady advertisement may refer to an advertisement displayed to users, which a steadily increasing number of users view based on a preset number of times the advertisement is displayed. Specifically, the Steady advertisement may refer to an advertisement which is viewed a steadily increasing number of times for a certain period of time.

For example, the Steady advertisement may refer to an advertisement viewed a number of times in the top 50% ratings during a period from December 2014 to January 2015, which is maintained for four weeks or longer. Further, the Steady advertisement may be determined on criteria by an advertising platform, similarly to steady sellers of online bookstores.

(4) The Serendipity advertisement may refer to an advertisement related to an advertisement display time, a default advertisement, or the like based on a user profile. That is, the Serendipity advertisement may include a target advertisement defined upon an advertising contract, an advertisement compulsory by a server administrator, and an advertisement related to a season/period/advertising date. Here, the target advertisement may be an advertisement set with main target information (age and gender) according to main consumer group for an advertisement provided by an advertiser or advertising agency upon an advertising contract.

As described above with reference to FIG. 2, the Serendipity advertisement needs to consider whether a user profile is present as a target to be provided by the advertiser or server administrator is set.

In the presence of a user profile, the Serendipity advertisement may be provided to a selected user having a profile corresponding to the target information. On the contrary, in the absence of a user profile, the Serendipity advertisement may infer a profile based on user related information or map the target information to profile information similar to a user tendency. Here, methods for inferring the profile information or mapping the similar profile information to the target information are irrelevant to the scope of the present disclosure, and various inferring algorithms and mapping algorithms may be used.

The Serendipity advertisement may include a default advertisement in an advertisement group compulsory by a server administrator to be necessarily displayed to all advertising targets within a specific period. Further, the Serendipity advertisement may include an advertisement related to an advertisement display time related to a season/period/advertising date and be provided based on a static condition, such as a season, time and day on which the advertisement is provided. For example, based on Children's Day regarding the advertisement related to the advertisement display time, a season/period/advertising date related advertisement may be an advertisement for children, such as advertisements for toys, school supplies, infant clothes and presents.

The advertisement providing server may generate an advertisement schedule for a user based on the foregoing advertisement group. Here, the advertisement providing server may generate a different advertisement for each user by adjusting proportions of advertisements included in each advertisement group.

Further, the advertisement providing server may add or delete an advertisement depending on characteristics of advertisements in addition to the above four kinds, and various advertisements may be defined.

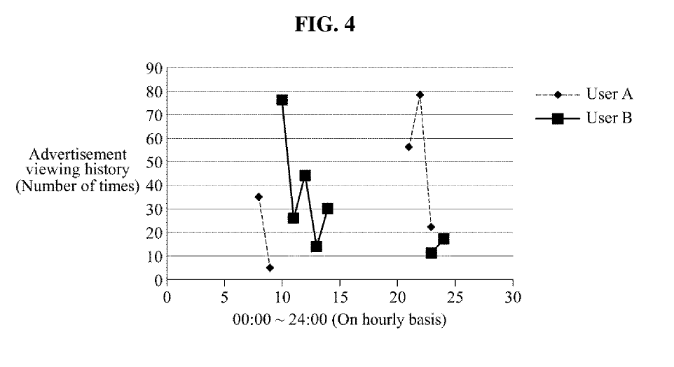

FIG. 4 illustrates an advertisement viewing history by time according to an example embodiment.

Referring to FIG. 4, an advertisement providing server may represent a distribution state of advertisements by time according to an advertisement viewing history of a user collected from a user device. Here, the advertisement providing server may hourly extract information on a time users view advertisements (“time information”) and express an accumulated number of times advertisements are viewed according to the extracted time information.

Accordingly, the advertisement providing server may identify a tendency of each user to view an advertisement, which may be used as base data for generating an advertisement schedule by time.

FIG. 5 illustrates a process of generating an advertisement schedule according to an example embodiment.

Referring to FIG. 5, an advertisement providing server may show specific advertisements for a Serendipity advertisement included in an advertisement group according to the presence of a user profile. That is, the advertisement providing server may provide an advertisement related to an advertisement display time and a default advertisement suitable for a user based on a user profile using different methods according to the presence of a user profile.

Referring to (a) of FIG. 5, the advertisement providing server may extract an advertisement to be recommended to a user in the absence of a user profile.

The advertisement providing server may create a contract-based advertisement in the absence of a user profile. That is, the advertisement providing server may infer a profile based on user related information or map profile information close to a user tendency to target information, thereby creating a contract-based advertisement.

Subsequently, the advertisement providing server may create an advertisement to be recommended to the user, such as a season-based advertisement, a season/period-based advertisement and a season/period/advertising date-based advertisement corresponding to static conditions, based on the created contract-based advertisement. That is, the advertisement providing server may extract an advertisement corresponding to the static conditions from advertisements which are classified according to rules or are associated with a season, period, and advertising date upon a contract. Further, overlapping conditions may be used in creating an advertisement and be considered according to priority.

Referring to (b) of FIG. 5, the advertisement providing server may extract an advertisement to be recommended to a user in the presence of a user profile.

In the presence of a user profile, the advertisement providing server may extract advertisements corresponding to user profile information based on the user profile. Subsequently, the advertisement providing server may extract an advertisement corresponding to target information set upon an advertising contract and extract an advertisement corresponding to a static condition compulsory by an advertising platform.

The advertisement corresponding to the static condition may be extracted by the same method as used above in (a) of FIG. 5.

Here, proportions of respective created advertisements may not exceed 1, and proportions of advertisements may be adjusted such that a sum of the proportions in an advertisement group does not exceed 1.

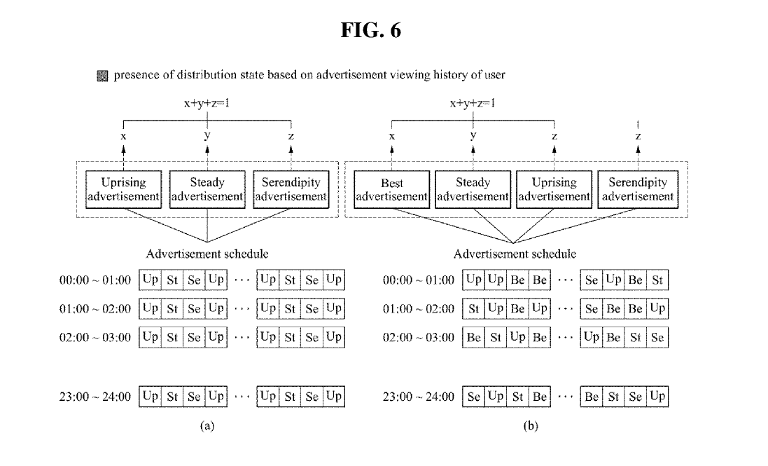

FIG. 6 illustrates a process of generating a different advertisement schedule depending on the presence of an advertisement viewing history according to an example embodiment.

Referring to FIG. 6, an advertisement providing server may generate an advertisement schedule for a user by changing advertisements included in an advertisement group and proportions of the advertisements according to the presence of a distribution state based on an advertisement viewing history of the user.

Here, the presence of the a distribution state based on the advertisement viewing history may mean that the user has experience in viewing a displayed advertisement and information on a user assessment and user preference for the viewed advertisement is given. That is, the advertisement providing server may determine whether the advertisement displayed to the user is an advertisement displayed for the first time or previously displayed advertisement.

Referring to (a) of FIG. 6, the advertisement providing server determines that the distribution state based on the advertisement viewing history of the user is absent.

Specifically, the advertisement providing server may collect the advertisement viewing history of the user from a user device. The advertisement providing server may identify based on the advertisement viewing history that an advertisement displayed to the user is an advertisement displayed for the first time.

That is, the advertisement providing server has no information to identify the user of the collected advertisement viewing history, such as preference and tendency of the user. Thus, the advertisement providing server may generate an advertisement schedule such that the same advertisement is scheduled for 24 hours in order to identify preference or tendency of the user to an advertisement.

For example, the advertisement providing server may identify whether the advertisement viewing history of the user is cold start that is first collected information. The advertisement providing server may generate an advertisement schedule including an Uprising advertisement, a Serendipity advertisement and a Steady advertisement except for a Best advertisement considering a user tendency.

Referring to (b) of FIG. 6, the advertisement providing server determines that the distribution state based on the advertisement viewing history of the user is absent.

The advertisement providing server may collect the advertisement viewing history of the user from a user device. The advertisement providing server may identify based on the advertisement viewing history that an assessment and preference are given to an advertisement displayed to the user.

That is, the advertisement providing server may determine an advertisement status so that a user viewing an advertisement identifies user preference and tendency to an advertisement. The advertisement providing server may create an advertisement included in a Best advertisement considering a user tendency based on the determined advertisement status.

The advertisement providing server may acquire the time-based distribution state based on the advertisement viewing history and thus acquire information on when the user views an advertisement, on an estimated time at which an advertisement is displayed, and on a day on which an advertisement is displayed. The advertisement providing server may schedule and provide advertisements at least hourly at based on a time when the advertisement schedule is delivered to the user on the basis of the acquired distribution state. That is, the advertisement providing server may schedule advertisements by time based on a time when the user views the user device.

Further, proportions of advertisements included in an advertisement group may be randomly adjusted based on policies or intent of a server administrator according to a distribution result based on the advertisement viewing history or be set based on rules. Further, as the advertisement viewing history is continuously collected from the user device and stored, the advertisement providing server may set a threshold for a particular data field of the distribution state based on the advertisement viewing history. The advertisement providing server may allow portions of advertisements included in the advertisement group to be automatically adjusted when exceeding the set threshold. A method of configuring or implementing a module for automatically adjusting advertisement portions is not limited in the present disclosure.

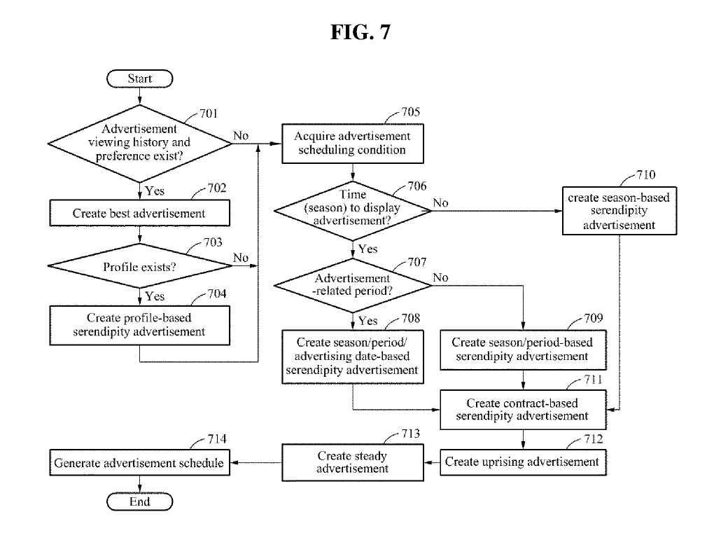

FIG. 7 is a flowchart illustrating a process of selecting an advertisement group using an advertisement schedule generating method according to an example embodiment.

In operation 701, an advertisement providing server may collect an advertisement viewing history of a user from a user device. The advertisement providing server may determine a distribution state of advertisements based on the collected advertisement viewing history. Here, the advertisement providing server may identify whether a previous advertisement viewing history and preference of the user based on the determined distribution state are present.

When the previous advertisement viewing history and preference of the user are absent (No) in operation 701, the advertisement providing server may acquire an advertisement scheduling condition in operation 705. When the preference is present (Yes) in operation 701, the advertisement providing server may create an advertisement included in a Best advertisement considering a user tendency in operation 702.

In operation 703, the advertisement providing server may identify whether a profile of the user is present, which is for a Serendipity advertisement based on static information.

When the profile of the user is absent (No) in operation 703, the advertisement providing server may acquire an advertisement scheduling condition in operation 705. When the profile of the user is present (Yes) in operation 703, the advertisement providing server may create a Serendipity advertisement based on the profile in operation 704. That is, the advertisement providing server may create a Serendipity advertisement by utilizing age and gender information on a member included in the profile in order to consider members of a viewing household viewing the user device.

When the profile is absent, the advertisement providing server may determine that it is impossible to create a Serendipity advertisement and acquire a static condition for an advertisement scheduling time.

In operation 705, the advertisement providing server may acquire an advertisement scheduling condition. That is, the advertisement providing server may acquire an advertisement scheduling condition for generating an advertisement schedule for the user by adjusting proportions of advertisements included in an advertisement group.

In operation 706, the advertisement providing server may identify a time to display an advertisement based on the static condition.

When it is not a time to display the advertisement (No) in operation 706, the advertisement providing server may create a season-based Serendipity advertisement in operation 710. When it is a time to display the advertisement (Yes) in operation 706, the advertisement providing server may identify whether the time is an advertisement-related period in operation 707. That is, the advertisement providing server may identify whether the time is a start date of the advertisement, an anniversary of the advertisement, or an advertisement-related period associated with a particular event for the advertisement.

When the time is not an advertisement-related period (No) in operation 707, the advertisement providing server may create a season/period/advertising date-based Serendipity advertisement in operation 708. When the time is an advertisement-related period (Yes) in operation 707, the advertisement providing server may create a season/period-based Serendipity advertisement in operation 709.

After operations 708, 709 and 710 are performed, the advertisement providing server may create a contract-based Serendipity advertisement in operation 711. That is, the advertisement providing server may create a contract-based Serendipity advertisement group which has higher priority or is forced to be displayed in a contract process, thereby creating a Serendipity advertisement. Ultimately, the advertisement providing server may investigate whether the acquired static condition is a season, period or advertising period to create a Serendipity advertisement based on a season/period/advertising date.

In operation 712, the advertisement providing server may extract an Uprising advertisement that is a newly registered advertisement, which is to be displayed according to an advertising contract with an advertiser or advertising agency, according to an execution history.

In operation 713, the advertisement providing server may extract a Steady advertisement that is an advertisement displayed to users, which a steadily increasing number of users view based on a preset number of advertisement display times.

In operation 714, the advertisement providing server may generate an advertisement schedule suitable for the user by adjusting proportions of the created advertisements in the advertisement group.

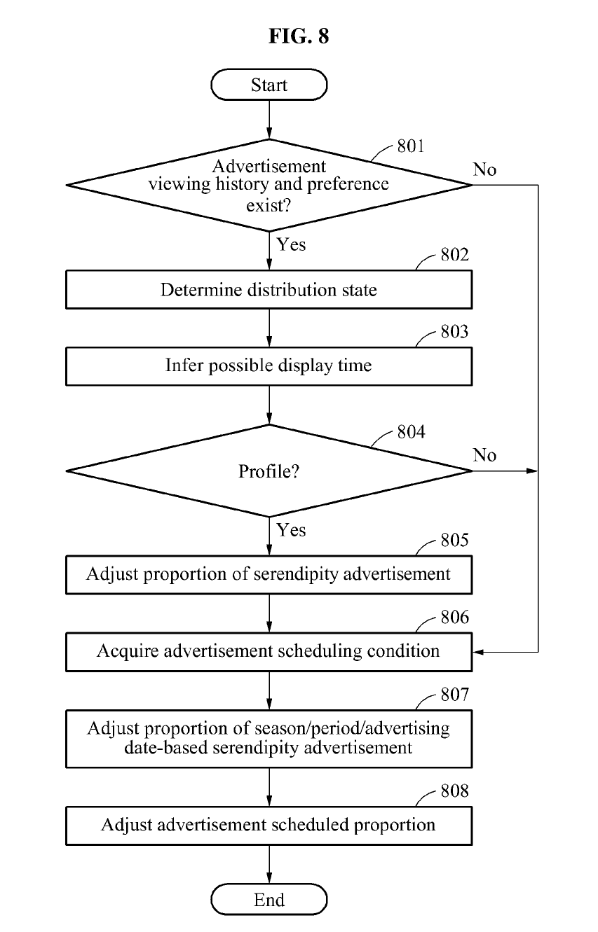

FIG. 8 is a flowchart illustrating a process of adjusting portions of advertisements in an advertisement group using an advertisement schedule generating method according to an example embodiment.

In operation 801, an advertisement providing server may identify whether an advertisement group extracted to generate an advertisement schedule includes a Best advertisement.

When the Best advertisement is included (Yes) in operation 801, the advertisement providing server may determine a distribution state of Best advertisements by time according to a advertisement viewing history of a user.

In operation 803, the advertisement providing server may acquire information on a time and day for displaying an advertisement according to the determined distribution state of the Best advertisements.

In operation 804, the advertisement providing server may identify whether a profile of the user is present.

When the profile of the user is present (Yes) in operation 804, the advertisement providing server may adjust a proportion of Serendipity advertisements in operation 805 and analyze static conditions for a time an advertisement is currently displayed through operations 806 to 808 to adjust a detailed proportion of Serendipity advertisements.

Here, advertisement scheduled proportions may be set for actual application based on proportions of respective advertisements in the advertisement group and rule and policy-based proportions set by the advertisement providing server. Using the set proportions, advertisements included in the advertisement group may be adjusted by time according to advertisement restriction rules based on an advertising contract, and an advertisement schedule may be generated based on an adjusted result.

Here, the advertisement scheduled proportions may be set according to a policy of an advertising platform. Alternatively, a baseline for the advertisement scheduled proportions may be set by implicit agreement and proportions of advertisement groups may be automatically increased or reduced according to variable scheduling conditions, thereby adjusting the advertisement scheduled proportions. Further, variations in the advertisement scheduled proportions may also be automatically adjusted through a statistical threshold according to rules or a steady increase in viewing history data. The present disclosure may employ generally-known machine learning techniques and classification techniques, without being limited to the foregoing methods.

The methods according to the example embodiments of the present disclosure may be realized as program instructions implemented by various computers and be recorded in non-transitory computer-readable media. The media may include, alone or in combination, the program instructions, data files, data structures, and the like. The program instructions recorded in the media may be designed and configured specially for the present disclosure or be known and available to those skilled in computer software.

While the present disclosure has been described with reference to a few example embodiments and the accompanying drawings, the present disclosure is not limited to the described example embodiments. Instead, it would be appreciated by those skilled in the art that various modifications and variations can be made from the foregoing descriptions.

Therefore, it should be noted that the scope of the present disclosure is not limited by the illustrated embodiments but defined by the appended claims and their equivalents.

What is claimed is:

1. A method of generating an advertisement schedule performed by an advertisement providing server, the method comprising:
collecting an advertisement viewing history of a user from a user device; and
generating an advertisement schedule for the user corresponding to the collected advertisement viewing history.

2. The method of claim 1, wherein the collecting comprises collecting an advertisement viewing history comprising a time at which the user views an advertisement and a category of the advertisement displayed at the time.

3. The method of claim 1, wherein the generating comprises determining a distribution state of advertisements displayed by time at which the user views the advertisements based on the advertisement viewing history.

4. The method of claim 3, wherein the generating comprises generating the advertisement schedule for the user by adjusting proportions of advertisements comprised in an advertisement group to be recommended to the user based on the distribution state of the displayed advertisements.

5. The method of claim 4, wherein the advertisement group comprises an Uprising advertisement newly added to be displayed to the user based on a registration date of an advertisement registered in the advertisement providing server.

6. The method of claim 4, wherein the advertisement group comprises a Steady advertisement displayed to the user which a steadily increasing number of users views based on a preset number of advertisement display times.

7. The method of claim 4, wherein the advertisement group comprises a Best advertisement recommendable according to a characteristic of the user in view of an advertisement displayed to the user and preference for an advertisement viewed by the user.

8. The method of claim 4, wherein the advertisement group comprises at least one Serendipity advertisement among an advertisement related to an advertisement display time and a default advertisement based on a profile of the user.

9. The method of claim 1, wherein the generating comprises generating an advertisement schedule with proportions of advertisements in an advertisement group being adjusted according to a preset priority based on at least one of the collected advertisement viewing history, preference of the user for an advertisement, and a profile of the user.

10. The method of claim 1, wherein the generating comprises generating an advertisement schedule for recommending an advertisement to the user by certain time corresponding to an estimated time at which an advertisement is displayable to the user based on the advertisement viewing history.

11. A method of generating an advertisement schedule performed by an advertisement providing server, the method comprising:
collecting an advertisement viewing history of a user who views an advertisement displayed through a user device;
determining a distribution state of advertisements displayed by time to the user based on the collected advertisement viewing history and a profile of the user; and
generating an advertisement schedule for the user using an advertisement group in which advertisements to be recommended to the user are classified according to the determined distribution state.

12. The method of claim 11, wherein the determining comprises determining the distribution state according to characteristics of the user and a household member using information on the household member comprised in the profiled of the user.

13. The method of claim 11, wherein the generating comprises generating an advertisement schedule with proportions of advertisements in an advertisement group being adjusted according to a preset priority based on at least one of the collected advertisement viewing history, preference of the user for an advertisement, and a profile of the user.

14. The method of claim 11, wherein the generating comprises generating an advertisement schedule for recommending an advertisement to the user by certain time corresponding to an estimated time at which an advertisement is displayable to the user based on the advertisement viewing history.

15. An advertisement providing server comprising:
a receiver configured to collect an advertisement viewing history of a user from a user device;
a processor configured to generate an advertisement schedule for the user corresponding to the collected advertisement viewing history; and
a transmitter configured to transmit the generated advertisement schedule to the user device.

16. The advertisement providing server of claim 15, wherein the processor determines a distribution state of advertisements displayed by time at which the user views the advertisements based on the advertisement viewing history.

17. The advertisement providing server of claim 16, wherein the processor generates the advertisement schedule for the user by adjusting proportions of advertisements comprised in an advertisement group to be recommended to the user based on the distribution state of the displayed advertisements.
